(19) United States
(12) Patent Application Publication
(10) Pub. No.: US 2015/0189166 A1
(43) Pub. Date: Jul. 2, 2015

(54) METHOD, DEVICE AND SYSTEM FOR IMPROVING THE QUALITY OF PHOTOGRAPHS

(71) Applicant: TELEFONICA DIGITAL ESPAÑA, S.L.U., Madrid (ES)

(72) Inventor: Jose San Pedro Wandelmer, Barcelona (ES)

(73) Assignee: TELEFONICA DIGITAL ESPAÑA, S.L.U., Madrid (ES)

(21) Appl. No.: 14/144,278

(22) Filed: Dec. 30, 2013

(51) Int. Cl. H04N 5/232; H04N 5/235

(52) U.S. Cl. CPC H04N 5/23222; H04N 5/2353; H04N 5/23293

(57) ABSTRACT

Disclosed herein are a method, system and device for improving the quality of photographs taken by a photo camera user. They provide, in real time, a continuous and customized auditory quality feedback to the user for an image displayed by the camera in the viewfinder, to help the user to decide whether to take a photograph or not for said image (that is, the photograph for said image has not been taken by the user yet). With the technical solution proposed herein, a more effective, faster and more accurate feedback is given to the photographer and more quality photos are taken saving camera resources at the same time.

### FIELD

The present invention relates generally to digital images, and more specifically to a method, device and a system for improving the quality of photographs taken by a photo camera user by assessing in camera the photo quality of digital images displayed by the photo camera.

### BACKGROUND

Photography presents unique challenges to the average (non-professional) user. Although conventional cameras may have the potential to achieve extremely high photo quality, because taking good photographs requires optimal tuning of multiple variables, the flexibility and ease of manipulation can produce generally inferior results if the user is not sufficiently skilled in photography. For instance, there are three main optical parameters of digital cameras that affect the correct exposure of photographs and are controllable by the photographer: shutter speed, aperture, and ISO sensitivity. While multiple combinations of values for these three variables can lead to similar exposure characteristics, each configuration produces a different final result. For example, high ISO sensitivity values can overcome the absence of proper illumination, but may result in noisy images. Additionally, slow shutter speeds can compensate for lack of illumination but will produce blurry images unless used with a tripod.

Modern cameras incorporate mechanisms to handle automatically the complexity of exposure configuration and provide high-level abstractions to the user so the best combination of values is chosen depending on the user-selected type of photograph (e.g., portrait, sports, landscape, etc.). Despite the existence of valid automatisms for exposure configuration, the quality of the photographs is not as good as it could be because photography has many additional aspects that influence the quality of the resulting image. For instance, correctly framing a compelling subject, cleverly combining complementary colors and textures, or removing distracting elements from the background can have a significant impact in the perceived aesthetic quality of the final result.

In contrast to the aforementioned optical parameters, conventional cameras do not have direct control over these other aspects. For instance, to remove a distracting element in the background of a photograph, the element has to be physically moved so that it does not appear in the frame anymore. Alternatively, the photographer could reposition the camera so that the element does not appear in the new composition. Both solutions rely on the users to actively control these aspects so that the best possible photograph is captured. Most users are unaware of simple photography rules and, therefore, lack the proper knowledge to control optimally all these parameters and variables.

### SUMMARY

The present invention solves the aforementioned problems, and technical advantages are generally achieved, by disclosing a method, system and devices for improving the quality of photographs taken by a photo camera user by providing quality feedback directly in photographic cameras. The method, system and devices in the embodiments proposed by the present invention will help camera users control photography aspects with the end of improving the overall quality of their captured photographs.

The proposed embodiments combine elements from two separate fields and builds upon them. These two fields are (i) automatic visual aesthetic inference; and (ii) in-camera feedback mechanisms.

Aesthetic inference refers to the method for computing automatically an aesthetic score for an image or other element. The field of automatic visual aesthetic inference deals with the problem of automatically inferring the aesthetic quality of still and moving images, with application to image search ranking, among other techniques. The works in this field acknowledge that beauty and artistic sense are very personal and vary between subjects. However, some features are positively perceived by a vast majority of people. For instance, composition schemes, such as the golden ratio, recurrently appear in paintings and photographs of distinguished artists. Indeed, there have been numerous research efforts on the analysis of visual information for aesthetic inference, using only visual features extracted from images or combining them with user generated metadata. The common approach presented in previous works follows a classic statistical inference model with an image representation stage and a model construction stage.

Image representation is includes defining a set of features to be extracted from images that serve as proxies for different aspects believed to have an influence on their perceived aesthetic value. For instance, features representing dominant colors, salient textures, or contrast are commonly extracted as they map important information from the image that is correlated with its aesthetic value.

Model construction includes building a model to predict aesthetic values for new images. The model takes the value of the features selected in the previous step to be extracted from the new image as input. Further, the model produces the predicted aesthetic value as output. These models can be expressed linearly and tuned experimentally or, more commonly, the models may utilize a supervised learning paradigm where observations from a labeled set of images are used to learn the optimal parameters of the model. Vast amounts of aesthetically scored images are available in online communities, such as photo.net, which can be crawled to collect sufficiently large corpora for training and building the inference models.

The second field of in-camera feedback mechanisms includes methods used by the cameras to provide feedback to the user about the operation of the device. There is a vast body of previous literature in this area. For instance, visual indicators in the camera screen can provide composition tips (e.g., rule of thirds) as well as inclination indicators. Also, audio cues have been used to inform users about exposure features of the photograph at focus time. One previous reference is U.S. Patent Application Publication No. 2012/268612, entitled “On-Site Composition And Aesthetics Feedback Through Exemplars For Photographers,” by Wang James Z et al (hereinafter “the '612 reference”). The '612 reference describes a method for enhancing the photographs captured by mobile consumers. Once taken by users, photographs are uploaded using the upstream data connection of the mobile device into a remote server that assesses the aesthetic quality of the snapshots. The server sends back examples of high quality photographs, which are similar in content and composition to the one just taken, so the users have the chance to reshoot the scene using the examples as a guide. Another reference is PCT International Patent Application No. WO03069559, entitled “Method And System For Assessing The Photo Quality Of A Captured Image In A Digital Still Camera,” by Lin Qian (hereinafter “the '559 reference”). The '559 reference describes a method for assessing the aesthetic quality of pictures taken by photographers directly in the hardware of the camera. The method operates firstly when a photographer or user takes a photograph with the camera. Once taken, a process that infers the aesthetic value of the captured photograph is run using a general purpose processor embedded in the camera. Lastly, the user is notified about the aesthetic acceptability of the picture captured.

Although the '612 and '559 references have various advantages, both of the described approaches have some limitations that limit their applicability in practical situations. For example, both references operate by following a lazy initialization strategy. That is, the aesthetic inference process is not executed until the user has effectively taken the photograph by pressing the button which activates the shutter. This pre-requirement hampers the effectiveness of both methods for guiding photography to users in two main ways. First, users are forced to take photographs to get the automatic aesthetic assessment. In the process of looking for an optimal image, they are forced to shoot multiple takes, filling up their storage and introducing redundant and noise images in their libraries. Second, taking the photograph introduces a delay before the aesthetic quality assessment (also called aesthetic assessment for shortening) can be retrieved, which has an impact on the ability of users to learn how their actions affect the aesthetic quality of the photograph, as experimenting using a trial-and-error strategy becomes too costly in terms of time. In order to maximize the effect of feedback, it needs to be conveyed back to the user as close as possible to real-time.

Additionally, the '612 reference requires offline processing by outsourcing the aesthetic analysis of the image to a remote server, using the data connection of the mobile device to this end. The latency associated to the transmission of data (uploading the photograph and downloading the selected examples) introduces a delay that could render the repetition of the photographs unfeasible (for instance, in cases where the main subject is moving in an uncontrollable fashion). The above-described latency limits the applicability of the example-based guidance in the '612 reference in many application scenarios.

Furthermore, both the '612 and '559 references are limited to visual-only feedback. In other words, the systems and methods of both references convey the aesthetic feedback to the photographer using the visual modality. The results of the aesthetic analysis are communicated using the screen of the camera/mobile, which occludes completely or partially the photographer's viewfinder. In a real-time setting where photographers use this feedback as a guide to improve their photos, occluding the viewfinder significantly limits the effectiveness of the approach, as it is the only interface element that allows users to preview their photographs before shooting them. Partially hiding the viewfinder has two main drawbacks. First, it limits the direct visual feedback channel provided by the camera to photographers, so the user loses information about the elements present in the image. Second, by limiting the visual feedback channel the users partially lose their ability to learn from any real-time guidance system implemented in the camera.

Other prior art literature has researched camera feedback mechanisms in modalities other than the visual. These works, however, are limited to very simple aspects of the photography activity (e.g., memory almost full, over/under exposed photo, etc.) and do not aim at providing complex real-time feedback concerning the aesthetic value of photographs.

In view of the above-described shortcomings of the prior art, the embodiments of the subject matter of the present disclosure stated below propose a new solution to improve the quality of photographs taken by a photo camera user, overcoming at least some of these drawbacks of the prior art solutions.

In one embodiment, a method is described for providing image quality feedback in a camera where the camera includes a screen (generally speaking, a preview module) to display images captured by the camera to be previewed by a camera user before taking a photograph. The method includes obtaining a quality score of an image displayed on the camera screen, dynamically composing a musical tune, where musical parameters of said musical tune are selected depending at least on the obtained quality score, and playing the musical tune.

According to one implementation, dynamically composing a musical tune includes selecting the value of a set of musical parameters based on the value of the quality score. The set of musical parameters may include a single parameter and it may include at least one of the following: tone, pitch, scale, tempo, rhythm, instrument or panning. Dynamically composing may also include generating harmony and/or melody of the musical tune based at least on the selected value of the set of musical parameters. The generation of the harmony and/or melody of the musical tune may be also based on a chord progression previously selected.

In some implementations, obtaining a quality score includes extracting representative features from the image displayed on the camera screen, and using a predictive model (also called a prediction model) for obtaining a score for the quality of the image based on the representative features extracted from the image. The representative features may be exposure features (from the distribution of luminance of image pixels) and composition features.

In yet some implementations, the predictive model is trained using a set of images previously labeled with a predetermined quality score as training data. Based at least on the training, the predictive model is able to assign a quality score to the image. The predictive model may be a regression model or it may be a classification model and it may use Support Vector Machines. The parameters of the predictive model may be changed based on an obtained location of the camera. In some implementations, the parameters of the predictive model can be changed based on camera user context information received by a remote server.

In certain implementations, the quality score may be an aesthetic quality score, such as a visual aesthetic quality score. The quality score of an image can be obtained by averaging the quality score of the last M images, where M is a design parameter. The steps of obtaining the quality score of a displayed image and composing and playing the musical tune may be performed before the user has taken a photograph for an image, and they can be performed even if the user does not take a photograph for the image. In an implementation, when an image displayed on the camera screen is replaced by a new image, a quality score is obtained for the new image and the musical parameters of the musical tune (e.g., the set of musical parameters) are modified according to the quality score of the new image and the new musical tune is played.

In yet another implementation, the musical tune is divided in bars and the method further includes, for every bar, if an image displayed on the camera screen at the time when a bar starts is different to an image displayed at the time when the bar is finished, a quality score is obtained for the image displayed at the time when the bar is finished and the musical parameters of the musical tune (e.g., the set of musical parameters) are modified according to the quality score of the image displayed at the time when the bar is finished.

According to another embodiment, a device for providing image quality feedback includes a screen to display an image captured by an image capture unit (e.g., a camera) to be previewed by the device user before taking a photograph, a processor, and an audio system to play a composed musical tune. The processor is configured to calculate a quality score of images displayed on the screen, and dynamically compose the musical tune, where the musical parameters of the musical tune are selected depending at least on the calculated quality score of the images.

In some implementations, the device includes the unit (the camera) capturing the image, or the camera may be external to the device and the camera sends the captured images to the device through a data connection.

According to yet another embodiment, a system for providing image quality feedback includes an image capture unit (e.g., a camera), a screen to display an image captured by the camera to be previewed by the camera user before taking a photograph, a processor, and an audio system to play a composed musical tune. The processor is configured to calculate a quality score of images displayed on the screen, and dynamically compose a musical tune, where the musical parameters of the musical tune are selected depending at least on the quality score of the images.

Additionally, according to some embodiments, a computer program that includes computer program code means adapted to perform the above-described method is presented. Further, in yet certain embodiments, a digital data storage medium that stores a computer program product with instructions causing a computer executing the program to perform the above-described method.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Corresponding numerals and symbols in the different figures refer to corresponding parts unless otherwise indicated. Understanding that these drawings depict only typical embodiments of the subject matter and are not therefore to be considered to be limiting of its scope, the subject matter will be described and explained with additional specificity and detail through the use of the drawings, in which:

FIG. 1 shows templates used in an example to extract the composition features of the images in an embodiment of the subject matter of the present disclosure;

FIG. 2 shows a flow chart with a schematic representation of the steps of the proposed method according to one of the embodiments of the subject matter of the present disclosure;

FIG. 3 shows a block diagram with a schematic representation of the architecture of a system for providing quality feedback in a photo camera according to an embodiment of the subject matter of the present disclosure; and

FIG. 4 shows a block diagram with a schematic representation of the architecture of a mobile phone implementing the method for providing quality feedback according to an embodiment of the subject matter of the present disclosure.

### DETAILED DESCRIPTION

Generally, the presented embodiments of the present disclosure potentially have, among others, the following main advantages when compared with the prior art: increased guidance effectiveness and auditory feedback.

In contrast with the prior art, the increased guidance effectiveness is realized by analyzing in real time the stream of images continuously captured by the camera to feed the live-view screen (instead of analyzing only the photographs already shot or already taken). This approach enables this invention to provide a more effective feedback to users in terms of guidance. Studies from the usability and persuasive computing research fields show that the likelihood of users performing an action is directly related to how easy it is to perform. The above-described patent references introduce the necessity of the user activating the shutter to take a photograph before they can obtain an assessment of their picture. Should the aesthetic value be too low, they need to point and shoot again before they know if their actions to increase the image quality had a positive or a negative effect. In contrast, the subject matter of the present application removes the need to shoot photos. Evaluations are computed in real time while the user moves the camera, which serves to encourage them to explore multiple different options using a trial and error strategy before they press the shutter and learn how their actions influence the final quality of the image at virtually no cost (not even pressing the shutter). Moreover, the prior art methods do not encourage users to explore different framings and compositions given that people will tend to avoid taking photos to only then assess the quality. Hence, most likely their photo taking decisions will be sub-optimal. By providing the right information (aesthetic quality assessment) at the right time (real-time evaluation when the user is looking at the camera), the subject matter of this disclosure increases the likelihood of users shooting higher-quality photos. This intuition has been studied and abundant evidence has been given in multiple research works on glance able interfaces: providing the right information at the right time significantly improves the performance of users towards achieving a specific goal.

The present subject matter also considers the manner in which aesthetic quality assessments are conveyed to users. Feedback assessments of the images framed by the camera are used to compose a music melody which is played back to the photographer during the photographic activity. The melody starts being generated and played from the moment the photographer switches on the camera and the devices starts registering images to feed the live-view screen. The aesthetic evaluation of these images serves to change dynamically specific attributes of the musical composition, which can be easily and intuitively interpreted by the photographer. This auditory feedback is not exclusive and can be complemented with other cues, including dynamic visual indicators in the live-view screen.

The advantages of the proposed auditory feedback are two-fold. First, in contrast to other auditory cues, such as pre-recorded sounds, music melodies have an organic temporal dimension that fits the requirements needed for this application. Note that the feedback needs to be continuous while the photographer is engaging in the activity, before (and also after) they take photographs, as long as the camera is switched on and the aesthetic feedback mode activated. Hence, the auditory feedback mechanism needs to provide cues of arbitrary duration that adapt to the changing conditions of the visual input channel. Smartly created musical melodies fulfill these two aspects. Second, in contrast to visual cues, auditory feedback does not occlude any portion of the live-view screen, maximizing the exposure that the photographers have to the visual feedback channel of the camera. This aspect allows users to have a significantly better idea of the characteristics of the images framed by the camera in real-time as this screen is used by digital cameras to provide a preview channel simulating a viewfinder.

Although originally (e.g., in old photo cameras), a viewfinder was the optical element used by a photographer to look through in order to have a direct view of the image framed by the camera. In the present text, the terms “viewfinder” and “live-view screen” are going to be used indistinctly to refer to the same concept: the screen normally located at the back of digital cameras and that serves the same purpose as the original optical counterpart (to have a direct view of the image framed by the camera).

The present subject matter includes a method, system and device for improving the quality of photographs taken by a photo camera user by providing quality feedback (e.g., aesthetic quality feedback) directly in photographic cameras (photo cameras). According to one embodiment, the method, system, and device include an automatic quality inference model that predicts scores for images framed by the photographer. The automatic quality inference model operates in real-time, thus not requiring the photograph to be actually captured (only framed and shown by the viewfinder) to compute and receive the assessment. This is achieved by computing quality assessments (e.g., aesthetic quality assessments) on the images captured by the electronic viewfinder of digital cameras, which are commonly used to feed the visual channel given to photographers in the live-view screen. Also, according to some embodiments, feedback is given to photographers using an audio modality by composing a musical tune that adapts on-the-fly to map the computed aesthetic value of the images.

In the present text, the term photo or photographic camera refers not only to a digital or analogical device with the specific purpose of taking photographs (e.g., a photographic camera) but to other electronic devices, including for example, a mobile telephone, a smart phone, a tablet, an electronic notepad, a personal digital assistant (PDA), a tablet, a laptop, Google glass, etc., that are capable of taking photographs and/or capturing images directly or through an external device.

According to some embodiments, the subject matter of the present disclosure considers a continuous real-time feedback (e.g., aesthetic feedback) channel with the photographer. Previous works dealing with photographic aesthetic feedback are limited to doing so at discrete time points, e.g., right after the photographer takes (captures) a photograph. The quality (e.g., aesthetic quality) inference models and feedback mechanisms of prior art systems cannot cope with the scenario of continuous real-time feedback for the following reasons, among others. First, prior art systems require the photographer to take the photograph in order to compute the aesthetic value. Second, prior art systems require offline quality analysis of the photograph, which introduces an additional delay because of the network transmission latency. Finally, the feedback mechanisms of prior art systems cannot handle a stream of multiple quality values because they are designed for providing feedback about a single assessment.

The subject matter of the present disclosure provides an aesthetic quality feedback to the photographer by composing a musical melody that maps the visual aesthetic information into the auditory modality. Accordingly, the subject matter of this disclosure avoids occluding any portions of the viewfinder maximizing the exposure that the photographers have to the visual feedback channel of the camera. While some previous works also use the audio modality for giving user feedback they are restricted to pre-recorded sounds (instead of musical melodies composed on-the-fly) and haven't been used to map complex information about aesthetics (only simple events, such as full storage). In contrast to pre-recorded sounds, music compositions can be dynamically changed and adapted to reflect the varying aesthetic properties of the images framed by the photographer.

In order to obtain the previously disclosed advantages and to perform the above disclosed solution, some embodiments of the present disclosure deal with achieving dynamism in the output audio stream, a dynamic threshold, visual quality modeling, visual-auditory mapping, and music generation.

According to some embodiments, the efficacy of the above-proposed solution to the shortcomings of the prior art relies on the ability to change the auditory feedback in response to the events observed in the input visual stream (e.g., the images shown by the camera to the user). Auditory feedback featuring musical nature is provided to the audience (it is addressed to the user using the photo camera but it will be listened by all the audience close to the photo camera). Accordingly, strict rules may govern what changes are allowed and how can they be applied so that musical character is not affected. Achieving dynamism in the output audio stream refers to the process followed to decide when the changes in the visual dimension (which will cause a change in the quality feedback in response to the events observed in the input visual stream) can be effectively reflected in the musical feedback. On the one hand, it is needed to make said reflection as immediate as possible. The minimum amount of time the user would need to wait is the interval between consecutive notes (fixed given the tempo in beats per minute, bpm, of the composition). On the other hand, it is needed to favor the musical quality of the output to avoid compromising the user experience. Compositions are generated by concatenating individually created chord progressions (as it is known, a chord is an harmonic combination of 2 or more notes played simultaneously and a chord progression is a set of chords that played in an ordered sequence creating an harmony). Waiting for the chord progression to end would be the maximum amount of time or delay before introducing the changes detected in the visual stream.

Both requirements have drawbacks. Introducing changes immediately after the current note breaks the music structure creates an audible pattern that can be perceived by the user as cacophonic and intrusive (worsening the musical quality). But waiting for the chord progression to finish could delay excessively the introduction of the visual event on the feedback channel. This dichotomy is solved by introducing the changes at an intermediate level: bars (or measures). Bars are time segments lasting for a fixed period of time; they define the minimum time structure in which notes are grouped. Hence, notes are grouped into bars, which are themselves grouped into progressions. Bars are fixed for a given composition and can be parameterized by the number of beats they last. This is normally specified as a time signature (e.g., ¾) where the top number defines the number of beats in the bar and the bottom number the note value of the beat. The time signature along with the BPMs value completely defines the duration of a bar in seconds. When a change in the visual stream happens at time tⱼ in the middle of a bar (for example, in the middle of a bar i, which starts at time t₀⁽ⁱ⁾ and finishes at time t_{f}⁽ⁱ⁾, it is waited until the end of the current bar (i), and starts reflecting that change into the feedback channel at time t_{f}⁽ⁱ⁾. This process introduces a delay in the communication of the changes in the visual input to the users, in this case said delay will be of t_{f}⁽ⁱ⁾−tⱼ seconds. Therefore, the number of changes that the system can convey per unit of time is limited. However, this parameter is always limited because, on the side of the user, detecting changes has an associated cognitive load, so they can only perceive changes up to a maximum frequency.

When there is a fixed threshold to decide about the quality of the image, the system may reach unstable states where, given the intrinsic error of the predictive quality model used, the metric (the quality score) keeps changing state because of the static nature of the threshold. In an example, in a sequence of 10 consecutive readings of the metric (that is the quality of 10 images is measured), the effective state changes 7 times, that is, the quality changes from being above the threshold to be below the threshold or vice versa, 7 times out of 10 readings.

Mapping such a rapid succession of different states is not desirable in terms of system usability. The constant change in state distracts the user and is perceived as noise as opposed to useful information. To avoid this effect, different smoothing mechanisms can be used. For example, in a moving average configuration, the previous M readings of the input signal are used to compute a smoothed value. That is, in an embodiment, instead of considering just the quality metric of the current image, a “smoothed” quality value is obtained for an image by averaging over the M last images (including the current one). Hence, short-term variations are effectively removed and state changes are less frequent even for a constant threshold. This configuration has one design parameter that would need to be tuned: M, the number of samples for computing the moving average. Typically M is chosen between 3 and 5, but this could be tuned depending on the processing power of the camera.

Another smoothing mechanism includes a historic mode configuration where the sequence of the last N output states is stored (that is, in the present case, the quality of the N last images). The new output state is computed by finding the state associated to the new read metric, including it in the historic buffer, and computing the mode of this buffer. The parameter to tune in this case is N, the number of previous states used to compute the mode. That is, in an embodiment, instead of considering just the quality metric of the current image, the mode of the N previous quality values and the value of the current image, is considered. The mode will be the value that occurs more often in the historic series. For example, if the series of image quality values is [low, low, mid-high, high,] the mode value would be “low”.

According to yet another mechanism, a Schmitt Trigger (hysteresis) configuration uses a different threshold for changing from a first state (low) to a second state (high) than the threshold used to go from the second to the first state, reducing the effective number of state changes when the variation in the input metric is low. The parameters that require tuning in this case are the margins above and below the threshold used to change state depending on the direction of the change (low to high or high to low).

A supervised learning strategy is used to build an aesthetic quality prediction model. Once trained, the model takes as input, images represented as a set of descriptive features. For each image represented using this feature representation, the model is able to predict its (visual quality) score. The use of Support Vector Machines (SVM, a classification and learning algorithm) is considered to derive two different visual quality prediction models, regression and classification-based, respectively. The same feature representation is used for representing visual content characteristics in both approaches, which only differ in the output that they generate: a scalar continuous value (regression) or a categorical value (classification).

As stated before, the presented solution needs to work in real time. This limits the amount of features that can be extracted to represent images captured by the camera and shown in the viewfinder. In order to represent the images as a set of descriptive features, many different procedures known from the prior art can be followed. For example, a representation scheme can be used based in the same principles stated in the previous work by Jose San Pedro et al. “Your opinion counts!: leveraging social comments for analyzing aesthetic perception of photographs”. In Proceedings of the SIGCHI Conference on Human Factors in Computing Systems (CHI '12). ACM, New York, N.Y., USA, 2519-2522 incorporated herein by reference, that establishes that exposure and composition features are the most influential in the subjective judgment of aesthetic value. In this exemplary representation technique, exposure features are extracted directly from the distribution of luminance of image pixels. RGB images filmed by the camera are transformed into the YUV color space, considering the Y channel (luminance). 7 exposure features are extracted from the distribution of the Y variable: minimum, maximum, mean, median, first quartile, third quartile and standard deviation.

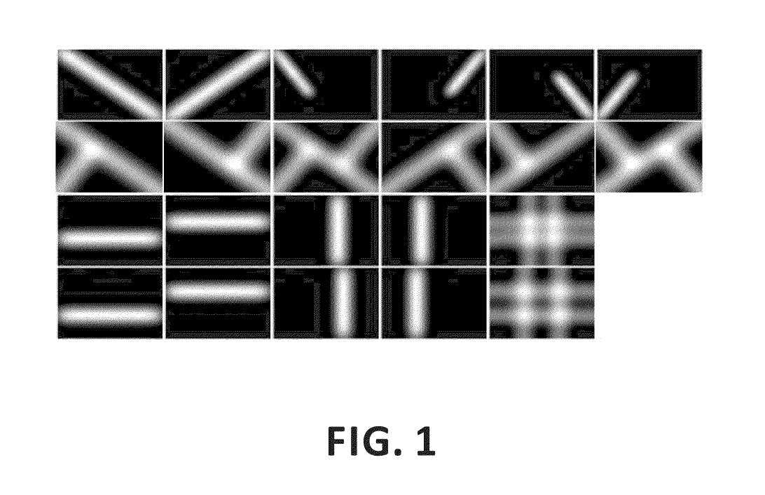

Composition features may be extracted following any well-known methods. For example, the schema proposed by Obrador et al. in U.S. Patent Application Publication No. 2013/188866 A1, which is incorporated herein by reference, may be one method. This schema includes the rule of thirds, the golden mean, and the golden triangles. Contrary to the schema proposed in this document, instead of detecting the centroids of the image regions obtained by segmentation, the edge map of the image can be extracted using the known Canny detection (e.g., an edge detection technique that uses a multi-stage algorithm to detect a wide range of edges in images, as it is disclosed for example by Jonh F. Canny in “A computational approach to edge detection” in IEEE TRANSACTIONS ON PATTERN ANALYSIS AND MACHINE INTELLIGENCE, VOL. PAMI-8, NO. 6, NOVEMBER 1986, which is incorporated herein by reference) and compute the percentage of edge energy that intersects with preselected templates (for example with each of the 22 templates depicted in the FIG. 1). All the 22 templates or just a subset of them can be used (it will depend mainly of the processing power of the camera).

One exposure feature per template used will be obtained. If 22 templates are used, in total, following this exemplary representation technique, 29 features will be used to represent each image, 7 exposure features and 22 composition features. In the above embodiment, as an example, a certain technique has been used to represent the images, but as stated before, many others known image feature representation techniques can be used.

As stated before, two different visual quality (e.g., aesthetic quality) prediction models, regression and classification-based respectively, can be used. With regard to the regression model, for training the regression model a dataset of pictures labeled with a numeric score of quality value (e.g., and aesthetic value) is necessary. This numeric score can be obtained in different ways. For example, from the judgment of a set of assessors and should take values in a scale (for example, from 0 to 100). A way to obtain large amount of rated photographs is to extract them from online communities of photography, such as DPChallenge or Photo.net. SVR (Support Vector Regression)-epsilon regression may be used to build the model using this training data (of course, any other regression models could be used for the same purpose). As a result, a predictive model is obtained able to compute scalar scores for previously unseen images. Such scores are trimmed to remain in the same scale (e.g 0 to 100) as the input ratings. After that, scores are discretized into a fixed number of K categories following any of the known approaches. For example, even division involves a score range that is evenly split into K parts of the same size. For instance, for K =4, the following 4 divisions (sub-ranges) will be obtained: A=[0, 25), B=[25, 50), C=[50, 75), D=[75, 100]. The final category (A, B, C or D) for an image would be determined by the division its score belongs to. As another example, quantile-based division assumes a given number K of output categories, where the range of scores is divided at K-quantile levels so that each of the divisions has the same number of images from the training set. The same procedure as in 1) is used to obtain the final category for a previously unseen image, that is, the final category for an image would be determined by the division its score belongs to.

The classification approach is associated with images that are labeled using a discrete number of K categories. For instance K=2 refers to binary classification. For example, recommended values for K are 3 (corresponding to levels ‘low’, ‘medium’, ‘high’), 4 (‘low’, ‘medium low’, ‘medium high’, ‘high’) and 5 (‘lowest’, ‘low’, ‘medium’, ‘high’, ‘highest’). Of course, any other value of K can be used, associating a corresponding level to each value. Support Vector Machines (SVM) with Radial-basis Function (RBF) kernel can be used to build the model using training data (a dataset of pictures previously labeled with a numeric score of quality value as in the Regression Model) using for example, the well-known “one-against-one” approach (also known as “pairwise coupling”, “all pairs” or “round robin”). It consists in constructing one SVM for each pair of categories. The SVMs are trained to distinguish the samples of one category from the samples of another category. This method requires training K(K-1)/2 predictors to generate the predictions, being K the number of categories used (the number of categories to detect). This is because, in order to be able to classify images into this K quality levels, it is needed to train one model/predictor (one SVM) for each pair of the K classes. So, the specific number of models which must be built is K*(K-1)/2, which is the number of combinations of K elements taking 2 at a time. Depending on the hardware this can be too slow. In that case, a standard Linear SVM can be used using the known “one-against-all” approach (constructing one SVM per category, which is trained to distinguish the samples of one category from the samples of all remaining categories) which requires only K predictors (K SVMs).

In both previously explained techniques, as a result, a predictive model able to compute categories for previously unseen images is obtained.

Visual-auditory mapping refers to the process followed to map attributes from the visual domain (the images filmed by the camera and displayed on the camera screen) in the auditory dimension. Only categorical variables (with a finite number of possible states) are suitable to be transmitted using the mapping described in this embodiment. Various auditory aspects altered to convey information can be considered. The following is not an exhaustive list of auditory aspects, as other hearing aspects also can be used.

Frequency-related aspects can include tone, pitch, and mode. For tone, Western music stems from a central (tonic) note. This note determines the actual value of the rest of the notes of the composition, which are defined as intervals from this tonic note. Tone refers here the note acting as the tonic note for the composition. There are 12 possible values for it. Pitch allows the ordering of sounds on a frequency-related scale, and refers to the octave being used. There are 11 octaves audible to the human hear. Modes or scales define a sequence of intervals from the tonic note, ultimately choosing the set of notes that will be used in combination. Major (Ionian) and minor (Aeolian) scales are the most commonly used scales in western music, and are normally associated with happy and melancholic tunes, respectively. There are 7 modes in modern western music: Lydian, Ionian, Mixolydian, Dorian, Aeolian, Phrygian, and Locrian.

Time-related aspects can include tempo and rhythm. Tempo refers to the beats per minute used to play the composition. Typical values for tempo are in the range 20 to 200. Rhythm refers to aspects related to note change rate and periodicity in the composition.

Character-related aspects (e.g., the way in which notes are sequenced) can include harmony and melody. Harmony refers to the use of several notes concurrently (chords), as well as the dynamics of chords in the time (chord progressions). Melody refers to a linear succession of notes (melody line) perceived as a continuous that follows the rules of the chosen tonality. Each visual attribute is mapped using either one of these two character types. The character attribute cannot be altered. The only possible change would be to go from one (e.g., melody) to another (e.g., harmony).

Other aspects may include instrumental aspects (e.g., the actual instrument(s) used to play the given notes, panning aspects (e.g., the difference of volume between the audio channels (e.g., right and left for stereo systems)), and amplitude/volume aspects (e.g., the average level (in decibels) used to play the notes).

Every phrase in the composition needs to select values for all these musical parameters. Visual attributes being mapped need to alter one or more of these parameters to signal the change in state. Several visual parameters can be mapped at the same time by altering a different set of musical parameters from this list. Depending on the application and the nature of the visual dimensions being mapped, the musical attributes more suitable for the mapping change.

Now an example of how the visual quality (e.g., aesthetic) score can be mapped into music is presented. In this example, the musical attributes of mode and pitch are selected and a categorization of quality scores into a number of K=4 classes or categories (0, 1, 2 and 3). Music mode deals with the emotional aspect of music, which depends on combination of specific note groups. The melancholic emotional value conveyed by minor scale tonalities can be used (in contrast to the optimistic value of major scales) to communicate low and high image quality values. To reduce the complexity of the mapping, the compositions can be limited to major and minor scales, by far the most commonly used in current popular music. This favors users' familiarity with the mode of the music played. The two lower levels of quality generate music in minor scale; the two higher, in major scale. That is, for an image with a quality with a category 0 or 1 a minor scale is used and for image quality with a category 2 or 3 a major scale is used. The pitch of the composition can then be used simultaneously with the mode, to further differentiate between levels: for the lowest quality level (0) a low pitch (bass) octave will be used, for the two medium levels (1 and 2) the middle octave (tenor) will be used and for the highest level (3) the highest octave (soprano) will be used.

A binary visual attribute (for example, the presence of faces in the image) can be signaled by activating/deactivating the presence of an additional instrument in the composition. To further emphasize the contrast between a categorical dimension (image quality) and an additional visual dimension (in this case, the binary dimension: presence of faces or not), not only the instrument may be changed (e.g., plano for image quality, choir for presence of faces) but a different musical composition element may be used for each visual dimension; for example, melody for one (e.g., image quality) and harmony for the other (e.g., presence of faces). This additional difference helps the listener to differentiate more easily between changes in each of these two visual dimensions.

Of course only some examples have been shown. A person of skill in the art would readily recognize that there are many other possibilities (using the above presented parameters) to map the quality score obtained for an image displayed on the camera screen, into music.

According to one embodiment, the musical composition process produces the final tune by generating a harmony line, a melody line, and a harmony. Generating the harmony line may include a random selection from a set of many chord progressions (for example, chord progressions found in popular music). The chord progressions may span for a number N, greater than 1, of bars. A melody, or sequence of notes, is generated over the next N bars using the harmony defined in the chord progression. To generate the melody, the notes of the current chord progression are considered and arpeggios (technique by which the notes of a chord are played in sequence, i.e. a group of notes which are played one after the other) are derived from them. Arpeggios can be generated by choosing them from a set of templates that define time, duration and pitch for each note in the arpeggio, making sure to meet all the musical parameters required by the visual mapping (explained in the previous section).

The harmony is generated by generating a set of chords, one for each bar of the chord progression. In particular, triads starting at the beginning of each bar derived from the current chord of the progression are used. In other words, the chord progression selected in the first step does not define exactly the actual chords used, but only a sequence of intervals from a tonic chord. For instance, a chord progression of 4 bars could be [I, IV, V, I] (chord progressions are normally written using roman numbers). In this step, to generate the set of chords, two decisions are made: (1) select the tonality; and (2) select the actual chords. In (1) a tonic chord is chosen that represents the first chord (“I”) of the progression; all other chords of the progression can then be inferred from the interval (e.g., “IV”) and the tonic (e.g., C). For instance, if C major is chosen as the tonality then the previous chord progression translates to C, F, G, C (i.e. Do, Fa, Sol, Do). Selection (2) refers to the chord “variation” used: standard chords are made of 3 notes (normally referred to as “triad”), but notes can be added/removed from this base. For instance, C6 adds the sixth note of the scale to the triad. These two parameters (tonic/tonality, and chord variation) can be used to modulate the music and be more effective in conveying information.

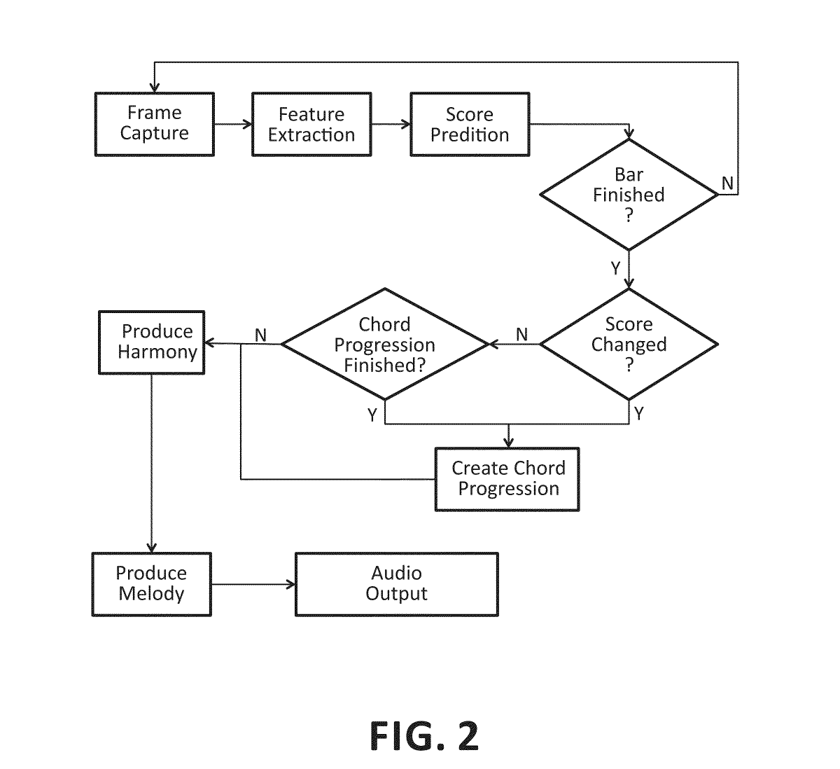

The final composition can be transformed into an actual auditory signal by transforming it into MIDI (Musical Instruments Digital Interface, a known standard) and playing it using a software or hardware MIDI sequencer. FIG. 2 shows a flow chart with the main steps of the proposed method for assessing image quality in a photo camera, according to one of the embodiments of the invention.

Referring to FIG. 2, frame capture refers to the frame capture process performed by the camera to feed the live-view screen/viewfinder, to preview the image previous to the act of taking the photograph by the user. That is, the frame (image) is captured and displayed to the user on the camera screen, before the user presses the button to take the photograph (e.g., to activate the shutter). Then a feature extraction score is predicted. As disclosed above in relation to visual quality modeling, for a captured image, representative features are obtained and with this representative features, a prediction model is fed to obtain a predicted quality score for said image.

According to FIG. 2, it is checked if the bar being played is finished. This is true if the current bar, parameterized by a time signature and the BPM, beats per minute, of the composition, has come to an end, that is, there are, effectively, no additional notes to be played for the current bar. If the bar is finished, then it is checked if the score has changed. If the bar being played is not finished, the method starts again (that is, it starts the feature extraction and score prediction for another image captured by the camera). However, if the score has changed (true only if the predicted quality score value has changed with respect to the score used to create the current Chord progression), then a new chord progression is created. If the score has not changed, it is checked if the current chord progression is finished. Then, if the current chord progression is finished, then a new chord progression is created. However, if the chord progression is not finished, then the harmony and melody are generated. So, even if the score has not changed, the harmony and the melody of the composition can change. This is done, because the melody and/or harmony need to change so that the composition has a dynamic musical nature, otherwise it would be repeating the same notes over and over again making the whole experience “boring”. However, when there are changes in the visual dimension additional attributes of the music change. For instance, if there are no more faces in the frame, the harmony is silenced and only the melody can be heard. Another example, if the image quality goes from High to Low the musical scale used to choose the notes for the melody changes from a Major scale to a Minor scale.

The process of FIG. 2 may include execution of an action by a create chord progression module that generates a chord progression, which is used to guide the production of the harmony and melody parts of the composition. Chord progressions may be selected randomly from a local database. Collections of chord progressions are publicly available from a number of sources. This corresponds to the previous explained action of “generating harmony line.”

A harmony can then be generated or produced as disclosed above with regards to visual-auditory mapping. In other words, a mapping is performed to generate a harmony (as previously explained) using as inputs the current aesthetic score and chord progression. Then, a melody is generated or produced as disclosed above with regards to visual-auditory mapping. In other words, a mapping is performed to generate a melody line (as previously explained) using as inputs the current aesthetic score and chord progression. Given the melody and harmony, and the current time t, outputs to corresponding notes of the composition are created using the device (e.g., camera) sound card. Based on said audio output, the user will decide if taking or not the photograph (for the image displayed in the live-view screen).

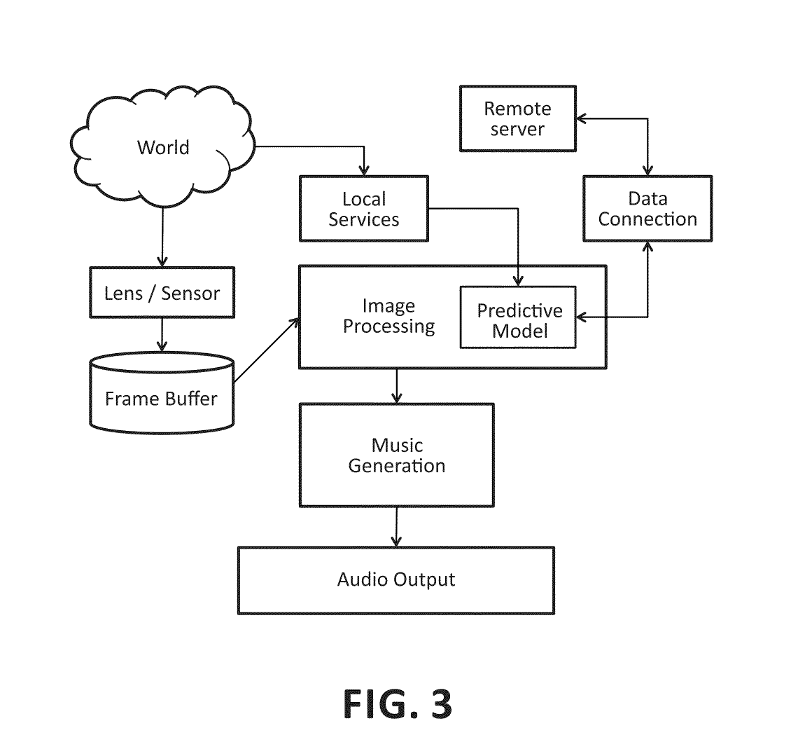

FIG. 3 shows a schematic representation of the generic architecture of a system according to one embodiment. FIG. 3 shows the different functional blocks which take part in the different functions involved in the proposed method for providing image quality feedback to the user of a photo camera. The lens/sensor refers to the parts of the camera responsible for capturing images from the world. Light reflected in the objects that made up the scene is focalized by the lens and, in a digital camera, registered by the sensor, which converts luminosity into digital images. Images (also called frames) captured by the lens/sensor part are stored in a memory buffer (e.g., frame buffer) so they can be displayed in the camera screen (viewfinder or live-view screen). The stored images will be used for the following modules to analyze the quality of the images visual parameters in real time.

An image processing or prediction module contains the elements necessary to perform the extraction of representative of a captured image and with this representative features and to obtain a predicted quality score for said image. Music generation contains the elements necessary to generate the music taking into account the predicted quality score. Data connection includes a communications connection that enables the system to communicate with a remote server. It can be implemented using any of the well-known techniques for data connection of a device.

Location information services of the camera can be sent to the photo camera or to a remote server to fine-tune the parameters of the prediction model either based on absolute position (e.g., latitude and longitude) or coarser geographical information (e.g., type and name of location, region name, country name, etc). This service allows the system to obtain said information about the geographical location of the camera. Said service may be even included in the photo camera (GPS). It can be implemented using any of the well-known techniques for device locations.

A remote server can be used to control the parameters of the prediction model. It can receive information about the context of the user (for example, gender, education level, photograph genre preferences, location etc.) and send back to the device (through the data connection) information updating its parameters, particularly the ones governing the prediction model. These components (data connection, location service and remote server) are optional. The device (the photo camera) is pre-programmed with a default set of parameters and can work without any updates. Having these three components allows to customize the model to the current situation of the user aiming at achieving improving prediction results.

Finally, audio output includes an interface able to transform the notes produced by the music generator into actual physical sounds perceivable by users (normally a speaker or headphones).

In an embodiment, the presented system of FIG. 3 can leverage information from the user context to change the prediction model in order to improve its accuracy. For example, one of the user context information can be the location of the user (the location of the camera). To this end, the system relies on the device providing location services (e.g., GPS). If location is available, it is sent over a data connection to a remote server that uses this information to select from a range of pre-defined prediction models for different geographical areas (country-based, city-based) or location types (city, mountain, beach, etc). These pre-defined prediction models (also called targeted prediction models) follows the same procedure as the generic prediction model (as explained in section Visual Quality Modeling) but using a set of images that best represent the types of photography typical in the particular area or location type where the camera is located. As stated before, the basic generic model, always available in the system in case the device has no location or data services.

As stated before, the presented embodiments can be applied not only to a photographic camera as such but to any device capable of taking photographs and/or capturing images, including for example a mobile telephone (e.g., a smart phone) or Google Glass.

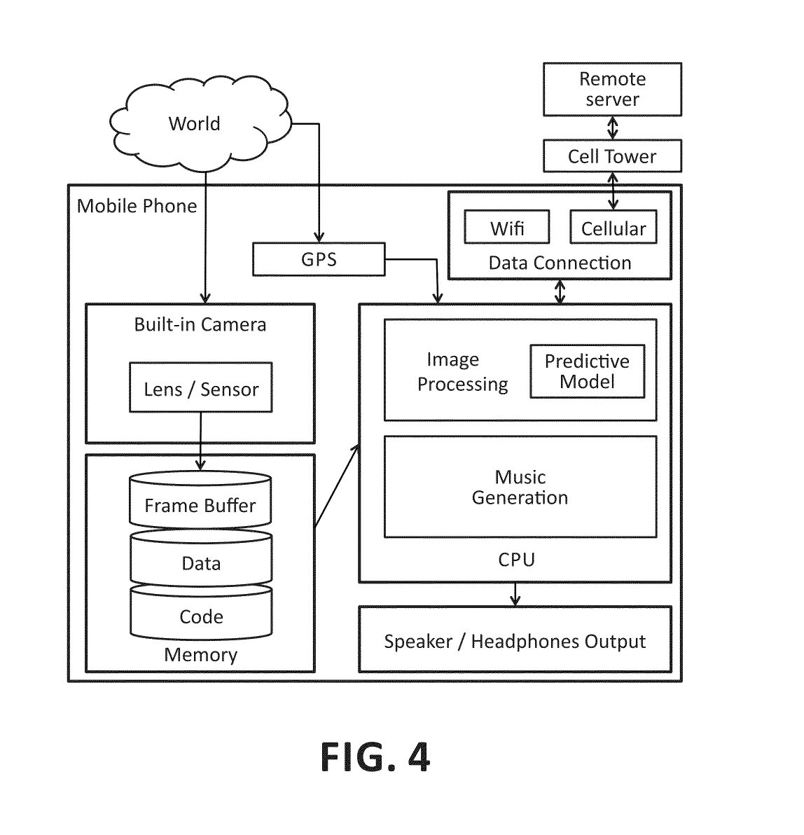

FIG. 4 shows a schematic representation of the architecture of a mobile phone implementing the method for providing quality feedback according to an embodiment of the invention. Also, FIG. 4 shows the different functional blocks which may take part in the different actions involved in the proposed method according to an embodiment. The blocks may include a camera built in the mobile phone, which may include the lens/sensor part of the generic previously explained architecture. The blocks may also include a frame buffer with a memory zone where frames used to feed the viewfinder are temporarily stored.

The architecture may also include image analysis, prediction model, and music generation modules. These modules may be analogous to the corresponding modules explained for the generic architecture. These modules run in the CPU. The code is stored in the memory, as well as the data needed to perform their tasks. The music generation module can use the MIDI sequencer of the mobile phone device for converting the composition into actual sounds.

The specific architecture of FIG. 4 can include a cellular connection and a built-in data service using the cellular connection. This connection is established through a base station of the mobile communications network. Information from the base station may be used to infer location information if the phone lacks a GPS service. A Wi-Fi Connection may optionally be included. The Wi-Fi or the cellular connection can be used to communicate with the remote server to improve the prediction model as previously explained.

The architecture may include a GPS module that functions to obtain a location using GPS service (if available in the phone). The location information will be used to improve the prediction model as previously explained. A speaker and/or headphones output can refers to speaker and headphone jacks built into the phone, and used to convey the quality feedback to the user ears.

In an alternative embodiment, the camera (with the lens/sensor) can be external to the mobile phone. The architecture will be very similar to the one presented in FIG. 4, only that the camera will be external to the mobile phone and the external camera will be connected through a data connection with the mobile phone. The camera will send the captured images to the mobile phone through said data connection and the images will be stored in the frame buffer of the mobile phone. An example of this case could be a head mounted camera (e.g., Google Glass) connected through Bluetooth to a smart phone device.

Summarizing, the subject matter of the present disclosure proposes a method, system and device for improving the quality of photographs taken by a photo camera user. It provides, in real time, a continuous and customized auditory quality feedback to the user for an image displayed by the camera in the viewfinder, to help the user to decide whether to take a photograph or not for said image (that is, the photograph for said image has not been taken by the user yet). With the technical solution proposed by the present invention, a more effective, faster and more accurate feedback is given to the photographer and more quality photos are taken saving camera resources at the same time. Even though some of the embodiments shown are referred to aesthetic quality feedback or aesthetic quality assessment, the present disclosure is not limited to this type of feedback or assessment but it can be applied to any other type of feedback, especially to any type of quality feedback or assessment (including for example technical quality). Further, even though some of the embodiments shown are referred to photo cameras, the present invention is not limited to this type of cameras but it can be applied to any other type of cameras able to capture images, for example to a video camera.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive.

What is claimed is:

1. A method for providing image quality feedback in a camera where the camera includes a screen to display images captured by the camera to be previewed by a camera user before taking a photograph, the method comprising:
obtaining a quality score of an image displayed on the camera screen;
dynamically composing a musical tune, wherein musical parameters of the musical tune are selected depending on at least the quality score of the image displayed on the camera screen; and
playing the musical tune.

2. The method according to claim 1, wherein dynamically composing a musical tune comprises:
selecting the value of a set of musical parameters based on the value of the quality score; and
generating at least one of harmony and melody of the musical tune based on at least the selected value of the set of musical parameters.

3. The method according to claim 2, wherein the at least one of harmony and melody of the musical tune is generated based on a previously selected chord progression.

4. The method according to claim 2, wherein the set of musical parameters comprises at least one of: tone, pitch, scale, tempo, rhythm, instrument, and panning.

5. The method according to claim 1, wherein obtaining the quality score comprises:
extracting representative features from the image displayed on the camera screen; and
using a predictive model for obtaining a score for the quality of the image based on the representative features extracted from the image.

6. The method according to claim 5, wherein the representative features are exposure features from the distribution of luminance of image pixels and composition features.

7. The method according to claim 5, wherein the predictive model is trained using a set of images previously labeled with a predetermined quality score as training data, and the predictive model is able to assign a quality score to the images based at least on said training.

8. The method according to claim 5, wherein the predictive model is a regression model or a classification model.

9. The method according to claim 5, wherein the predictive model uses support vector machines.

10. The method according to claim 1, wherein the quality score is an aesthetic quality score.

11. The method according to claim 1, wherein when an image displayed on the camera screen is replaced by a new image, a quality score is obtained for said new image and the musical parameters of the musical tune are modified according to the quality score of the new image.

12. The method according to claim 1, wherein the musical tune is divided in bars, and wherein the method further comprises for every bar, if an image displayed on the camera screen at the time when a bar starts is different to an image displayed at the time when the bar is finished, obtaining a quality score for the image displayed at the time when the bar is finished and modifying the musical parameters of the musical tune according to the quality score of the image displayed at the time when the bar is finished.

13. The method according to claim 5, wherein the method further comprises:
obtaining the location of the camera; and
changing the parameters of the predictive model based on the location of the camera.

14. The method according to claim 5, wherein the method further comprises:
receiving information about the user context at a remote server; and
changing the parameters of the predictive model based on the camera user context information received at the remote server.

15. A device for providing image quality feedback, the device comprising:
a screen to display an image captured by a camera to be previewed by the camera user before taking a photograph;
a processor configured to calculate a quality score of images displayed on the screen, and dynamically compose a musical tune, wherein the musical parameters of the musical tune are selected depending on at least the quality score of the images; and
an audio system to play the composed musical tune.

16. The device according to claim 15, wherein the device additionally comprises the camera.

17. The device according to claim 15, wherein the camera is external to the device and the camera sends the captured images to the device through a data connection.

18. A system for providing image quality feedback, the system comprising:
a camera;
a screen to display an image captured by the camera to be previewed by the camera user before taking a photograph;
a processor configured to calculate a quality score of images displayed on the screen, and dynamically compose a musical tune, wherein the musical parameters of the musical tune are selected depending on at least the quality score of the images; and
an audio system to play the composed musical tune.

19. A computer program comprising computer program code means adapted to perform functions when the program is run on programmable hardware, the functions comprising:
obtaining a quality score of an image displayed on the camera screen;
dynamically composing a musical tune, wherein musical parameters of the musical tune are selected depending on at least the quality score of the image displayed on the camera screen; and
playing the musical tune.

20. A digital data storage medium storing a computer program product comprising instructions causing a computer executing the program to perform functions, the functions comprising:
obtaining a quality score of an image displayed on the camera screen;
dynamically composing a musical tune, wherein musical parameters of the musical tune are selected depending on at least the quality score of the image displayed on the camera screen; and
playing the musical tune.
